(19) United States
(12) Patent Application Publication
(10) Pub. No.: US 2007/0292617 A1
(43) Pub. Date: Dec. 20, 2007

(54) Designer pine straw preparation process

(76) Inventors: Jack Mason, Beech Island, SC (US); Nedra Ann Mason, Beech Island, SC (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/454,917

(22) Filed: Jun. 16, 2006

(51) Int. Cl. B05D 7/00; B05D 3/02; B05C 5/00; B05C 13/02; B02C 13/00

(52) U.S. Cl. 427/372.2; 427/421.1; 241/28; 118/324; 118/66; 118/58; 241/185.5

(57) ABSTRACT

A method for creating colored pine straw comprising chopping a quantity of pine straw; spraying the pine straw with a coloring agent; drying the pine straw and; placing the dried pine straw into containers.

### FIELD OF THE INVENTION

The present invention is directed toward the field of pine straw fabrication. In particular, the present invention is directed to the fabrication of colored pine straw for use as mulch.

### BACKGROUND OF THE INVENTION

Pine straw is typically used as mulch for around plants, trees and shrubs. There have been a number of patents directed to the use of pine needles and the like. Recently, colored pine straw has gained popularity. Colored pine straw is both environmentally safe and preserves moisture.

A number of U.S. Patents have been directed to the use of pine needles. U.S. Patent Application No. 2002/0192402 to Parker discloses a decorative pine needle. It is characterized in that, a whole pine needle will consist of a cluster of elongated leaves that can be detached at the base, and each leaf can be used separately. The whole pine needle will be primarily used for indoor decoration projects. Said detached leaves are used primarily in decorating underneath shrubs, flowers, around trees, in artistic landscaping designs, and used generally for mass production.

U.S. Pat. No. 4,156,308 to Gebhart discloses a method of making a basket-like or other decorative article from pine needles comprising the steps of twisting and arranging pine needles, stitching the pine needles with a sewing needle and thread, so as to form a surface or wall, forming a basket-like object, the outer and inner surfaces of which are sealed with a protective coating, such as varnish.

U.S. Patent Application No. 2005/0031802 to Monks discloses a decorative pine cone display with visually pleasing color and sensory appealing aroma by dissolving selected color dye and scented oil in hot liquefied beeswax utilized to form a coating on a specific pine cone assembly whereby warming of the coating promotes release of pleasant aroma in the general area of the display structure.

U.S. Pat. No. 6,386,144 to Cathey discloses a method of producing an organic fertilizer from a highly absorbent animal bedding material manufactured from recycled waste paper, cotton fiber and cotton gin waste, and gypsum. The recycled waste products are combined to form a slurry mixture for processing by conventional paper making machinery into sheet material. Various chemical additives are admixed to the slurry mixture to control bacterial growth in the bedding material. The sheet material is further processed into sized particles to provide an animal bedding such as poultry litter. After the highly absorbent material is saturated with nutrient-rich animal excrement, it is subjected to chemical analysis and further processed to provide a biodegradable, organic fertilizer. The absorbent bedding material has alternative uses such as for collection of liquid chemical spills and for the remediation of such spills by biodegradation. The converted organic fertilizer can also be used as a ruminant feed after chemical analysis and the elimination of harmful microorganisms.

While there have been systems for creating pine straw or related media with coloring, there has not been a system for easily coloring pine straw.

It is an object of the present invention to provide a system for creating colored pine straw.

It is a further object of the invention to provide a system for creating and packaging colored pine straw.

It is an object of the present invention to provide a pine straw coloring and sorting system.

These and other objects of the invention will become clear from the detailed description which follows.

### SUMMARY OF THE INVENTION

In accordance, the invention is a method for creating colored pine straw comprising chopping a quantity of pine straw; spraying the pine straw with a coloring agent; drying the pine straw; and placing the dried pine straw into containers.

In a further embodiment, the invention is a method for coloring pine straw comprising chopping a preset quantity of pine straw; utilizing a sprayer unit to color the pine straw; applying heated air to colored pine straw to cause it to tumble and dry; placing the dried pine straw in a hopper; and placing the pine straw in the hopper into a plurality of containers.

In yet a further embodiment, the invention is a system for coloring pine straw comprising an input for feed of a quantity of pine straw into the system; a hammer mill for chopping the pine straw; a first conveyor for conveying the pine straw to the spraying station for spraying the pine straw with a colorant; a second conveyor for conveying the colored pine straw to a dryer station, the dryer station providing heated pressurized air to dry and tumble the colored pine straw; and a third conveyor for transporting the dried pine straw to a storage bin.

### DESCRIPTION OF THE FIGURES

FIG. 1 is a perspective view of the options of the present invention.

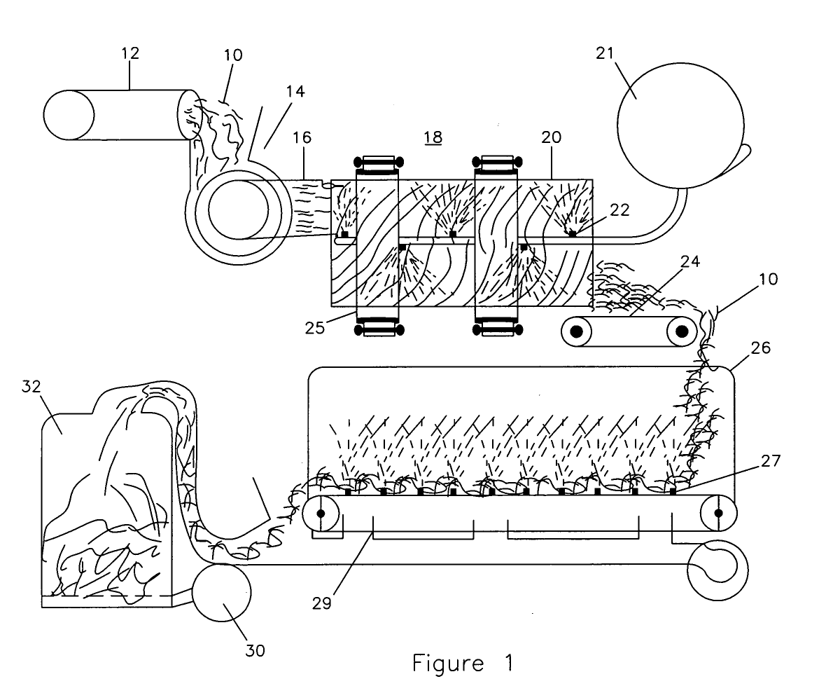

FIG. 2 is a view of the hopper and sorting options of the invention.

### DESCRIPTION OF THE PREFERRED EMBODIMENT

The present invention is described with reference to the enclosed Figures wherein the same numbers are referenced where applicable. The invention provides a mechanism and method for making and sorting colored pine straw. The invention incorporates a plurality of mechanical apparatus for carrying out the purpose of the invention. Pine straw is a popular mulch for use by landscapers and gardeners.

The invention incorporates an input conveyer 12 to input a quantity of pine straw 10. The pine straw 10 is then fed to a hammer mill 14 where it is chopped. The hammer mill will have a plurality of cutting sheers to control the size of the cut needles.

A second conveyor 16 then moves the chopped pine straw to a spray coloring unit 18. In a most preferred embodiment, the spray coloring unit 18 comprises a rotating bin 20 which is powered by a rotating mechanism 25. A spray colorant is then fed by high pressure nozzles 22 from a tank 21 into the bin 20 and onto the needles. The rolling spray unit fully covers the chopped pine straw with coloring agent.

A third conveyor 24 then takes the colored straw and moves it into a high pressure air drying unit 26. The dryer unit comprises a container. High pressure heated air, fed from the bottom 27 of the dryer dries the pine straw which is moved by a fourth conveyor 29 toward a blower 30. The blower 30 blows the dried painted straw into a storage bin 32. In an optional station, fertilizer can be selectively added to the straw.

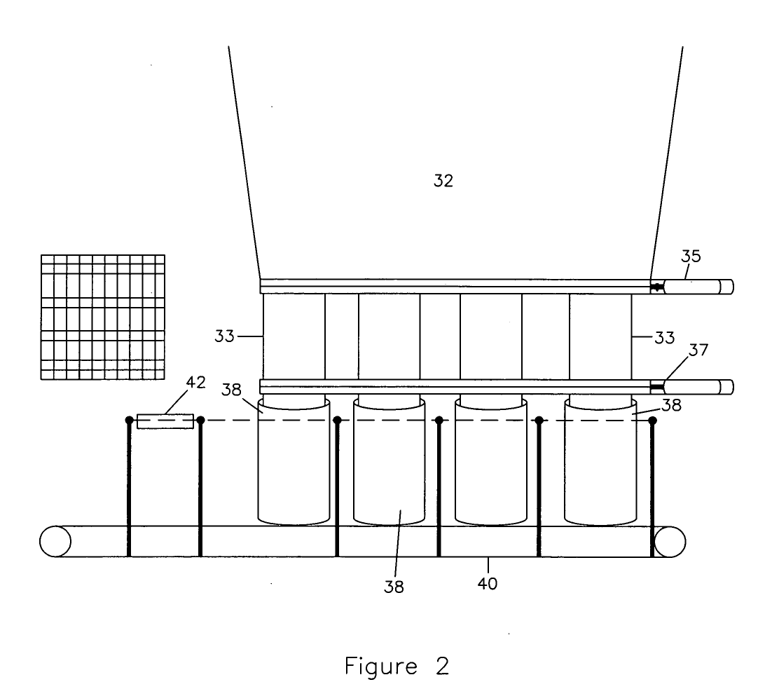

Referring to FIG. 2, the storage bin 32 is situated above a plurality of hoppers 33. The hydraulic cylinder 35 opens and closes the storage bin to permit the colored pine straw to drop into hoppers 33. The hoppers 33 may comprise a plurality of sizes and hold between 2-5 square feet of straw. A second hydraulic cylinder 37 opens and closes to permit the hoppers 33 to empty into containers 38. The containers 38 then proceed by a conveyor 40 to a sealing unit 42.

The present invention has been described with reference to the above discussed preferred embodiment. The true nature and scope of the invention is to be determined with reference to the attached claims.

1. A method for creating colored pine straw comprising:
chopping a quantity of pine straw;
spraying the pine straw with a coloring agent;
drying the pine straw; and
placing the dried pine straw into containers.

2. A method for coloring pine straw comprising:
chopping a preset quantity of pine straw;
utilizing a sprayer unit to color the pine straw;
applying heated air to colored pine straw to cause it to tumble and dry;
placing the dried pine straw in a hopper; and
placing the pine straw in the hopper into a plurality of containers.

3. A system for coloring pine straw comprising:
an input for feed of a quantity of pine straw into the system;
a hammer mill for chopping the pine straw;
a first conveyor for conveying the pine straw to the spraying station for spraying the pine straw with a colorant;
a second conveyor for conveying the colored pine straw to a dryer station, the dryer station providing heated pressurized air to dry and tumble the colored pine straw; and
a third conveyor for transporting the dried pine straw to a storage bin.

4. The system of claim 3 further comprising means for selectively adding a fertilizer agent to the pine straw.
